(19) United States
(12) Patent Application Publication
(10) Pub. No.: US 2021/0357831 A1
(43) Pub. Date: Nov. 18, 2021

(54) INFORMATION PROCESSING DEVICE, INFORMATION PROCESSING SYSTEM, PROGRAM, AND INFORMATION PROCESSING METHOD

(71) Applicant: TOYOTA JIDOSHA KABUSHIKI KAISHA, Toyota-shi (JP)

(72) Inventors: Xin JIN, Nagoya-shi (JP); Takayuki Murase, Toyota-shi (JP); Tadahiro Kashiwai, Nagoya-shi (JP); Toru Takashima, Susono-shi (JP); Hiroaki Hanzawa, Toyota-shi (JP); Hideo Hasegawa, Nagoya-shi (JP)

(73) Assignee: TOYOTA JIIDOSHA KABUSHIKI KAISHA, Toyota-shi (JP)

(21) Appl. No.: 17/235,261

(22) Filed: Apr. 20, 2021

(30) Foreign Application Priority Data
May 13, 2020 (JP) 2020-084605

(51) Int. Cl. G06Q 10/06; G07B 15/02; G06Q 50/30; G06Q 30/02; G08G 1/09

(52) U.S. Cl. CPC G06Q 10/06313; G07B 15/02; G06Q 50/30; G01C 21/3476; G08G 1/09; G06Q 2240/00; G06Q 30/0284

(57) ABSTRACT

An information processing device includes a control unit associates a new rideshare request with a traffic plan of a mobile body based on a user attribute when receiving the new rideshare request including boarding and alighting conditions and the user attribute from a first terminal device, associates the new rideshare request with the traffic plan in which the ancillary conditions and the user attributes of the new rideshare request satisfy the ancillary conditions of the existing rideshare request and the ancillary conditions and the user attributes of the existing rideshare request satisfy the ancillary conditions of the new rideshare request when the new rideshare request includes ancillary conditions and the existing rideshare request associated with the traffic plan includes ancillary conditions, and calculates a fee for the new rideshare request based on at least one of a type and the number of the ancillary conditions for the new rideshare request.

### INCORPORATION BY REFERENCE

The disclosure of Japanese Patent Application No. 2020-084605 filed on May 13, 2020 including the specification, drawings and abstract is incorporated herein by reference in its entirety.

### BACKGROUND

### 1. Technical Field

The present disclosure relates to information processing devices, information processing systems, programs, and information processing methods.

### 2. Description of Related Art

It is desired that people can travel while being able to board and alight at their desired locations. In order to achieve such a purpose, a system that enables rideshare is has been studied. For example, it has been proposed that by receiving a request for boarding, a path satisfying the request is determined, and a route of a multi-passenger vehicle is updated based on the path (see Japanese Patent No. 6027280 (JP 6027280 B)).

### SUMMARY

However, in the rideshare, the rideshare requesters having different preferences are combined. Therefore, in an attempt to satisfy the desires of some rideshare requesters, other rideshare requesters may feel uncomfortable. Thus, it was difficult to satisfy the desires of the rideshare requesters.

An object of the present disclosure made in view of such circumstances is to provide an information processing device, an information processing system, a program, and an information processing method that satisfy desires of rideshare requesters in rideshare.

An information processing device according to an embodiment of the present disclosure includes: a communication unit that communicates information with a first terminal device; and a control unit that associates a new rideshare request with a traffic plan of a mobile body based on a user attribute, when the communication unit receives the new rideshare request including boarding and alighting conditions and the user attribute from the first terminal device, wherein when the new rideshare request further includes an ancillary condition and an existing rideshare request associated with the traffic plan includes the ancillary condition, the control unit associates the new rideshare request with the traffic plan in which the ancillary condition and the user attribute of the new rideshare request satisfy the ancillary condition of the existing rideshare request and the ancillary condition and a user attribute of the existing rideshare request satisfy the ancillary condition of new the rideshare request, and calculates a fee for the new rideshare request based on at least one of a type and the number of the ancillary conditions for the new rideshare request.

An information processing system according to the embodiment of the present disclosure includes an information processing device. The information processing device includes a communication unit that communicates information with a first terminal device, and a control unit that associates a new rideshare request with a traffic plan of a mobile body based on a user attribute, when the communication unit receives the new rideshare request including boarding and alighting conditions and the user attribute from the first terminal device. When the new rideshare request further includes an ancillary condition and an existing rideshare request associated with the traffic plan includes the ancillary condition, the control unit associates the new rideshare request with the traffic plan in which the ancillary condition and the user attribute of the new rideshare request satisfy the ancillary condition of the existing rideshare request and the ancillary condition and a user attribute of the existing rideshare request satisfy the ancillary condition of new the rideshare request, and calculates a fee for the new rideshare request based on at least one of a type and the number of the ancillary conditions for the new rideshare request. The information processing system includes the first terminal device, and a second terminal device that communicates the traffic plan with the information processing device.

A program according to the embodiment of the present disclosure causes a computer to perform operations including: receiving a new rideshare request from a first terminal device; in execution of association of the new rideshare request with a traffic plan of a mobile body based on a user attribute in a case of receiving the new rideshare request including boarding and alighting conditions and the user attribute from the first terminal device, when the new rideshare request further includes an ancillary condition and an existing rideshare request associated with the traffic plan includes an ancillary condition, associating the new rideshare request with the traffic plan in which the ancillary condition and the user attribute of the new rideshare request satisfy the ancillary condition of the existing rideshare request and the ancillary condition and a user attribute of the existing rideshare request satisfy the ancillary condition of the new rideshare request; and determining a fee for the new rideshare request based on at least one of a type and the number of the ancillary conditions for the new rideshare request.

An information processing method according to the embodiment of the present disclosure, the computer receiving a new rideshare request from a first terminal device; in execution of association of the new rideshare request with a traffic plan of a mobile body based on a user attribute in a case of receiving the new rideshare request including boarding and alighting conditions and the user attribute from the first terminal device, when the new rideshare request further includes an ancillary condition and an existing rideshare request associated with the traffic plan includes an ancillary condition, associating the new rideshare request with the traffic plan in which the ancillary condition and the user attribute of the new rideshare request satisfy the ancillary condition of the existing rideshare request and the ancillary condition and a user attribute of the existing rideshare request satisfy the ancillary condition of the new rideshare request; and determining a fee for the new rideshare request based on at least one of a type and the number of the ancillary conditions for the new rideshare request.

With the information processing device, the information processing system, the program, and the information processing method according to the embodiment of the present disclosure, desire of the rideshare requester can be satisfied.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a configuration diagram showing an overall configuration of an information processing system including an information processing device according to an embodiment of the present disclosure;

FIG. 2 is a first flowchart of an association process executed by a control unit of the information processing device of FIG. 1 in the embodiment;

FIG. 3 is a second flowchart of the association process executed by the control unit of the information processing device of FIG. 1 in the embodiment; and

FIG. 4 is a flowchart of an ancillary condition addition process executed by the control unit of the information processing device of FIG. 1 in the embodiment.

### DETAILED DESCRIPTION OF EMBODIMENTS

Hereinafter, embodiments of the present disclosure will be described below with reference to the drawings.

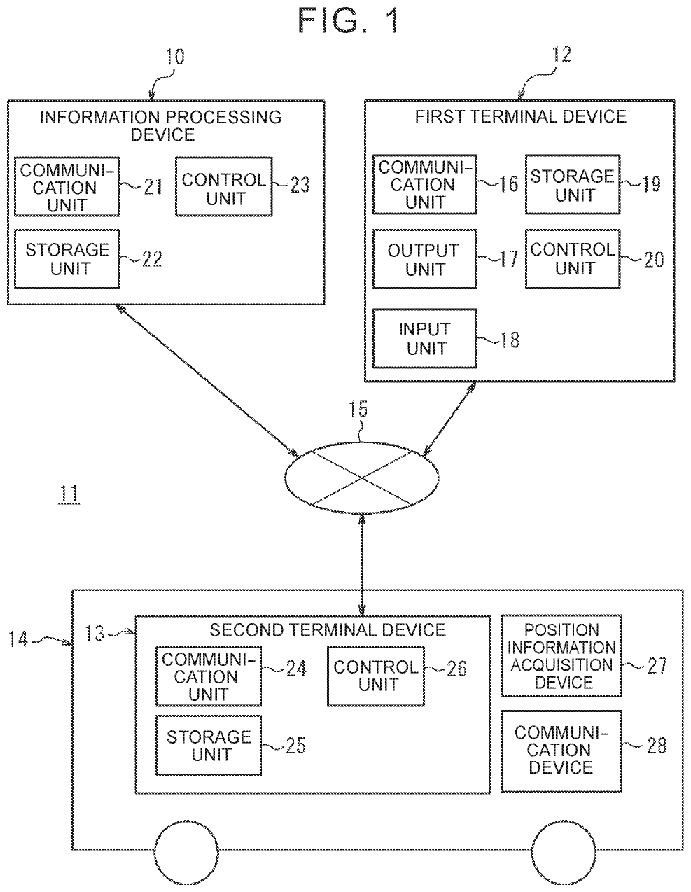

An outline of an information processing system 11 including an information processing device 10 according to an embodiment of the present disclosure will be described with reference to FIG. 1. The information processing system 11 includes a first terminal device 12, the information processing device 10, and a second terminal device 13.

The first terminal device 12 is, for example, a general-purpose electronic device such as a smartphone or a personal computer (PC), but is not limited to these, and may be an electronic device dedicated to the information processing system 11. The information processing device 10 includes one server or a plurality of servers that can communicate with each other. The second terminal device 13 is, for example, a dedicated electronic device such as a car navigation device mounted on a mobile body 14 traveling on a road such as a vehicle, but is not limited to this. For example, the second terminal device 13 may be a general-purpose electronic device such as a smartphone or other mobile terminal device. Although one first terminal device 12 and one second terminal device 13 are shown in FIG. 1 for the sake of simplicity of description, the information processing system 11 may include one or more first terminal device 12 and one or more second terminal devices 13.

Each of the first terminal device 12, the second terminal device 13, and the information processing device 10 is connected to a network 15 including, for example, a mobile communication network and the Internet so as to be able to communicate with each other. At least part of the information processing system 11 may be used to provide mobility services (Mobility-as-a-Service (MaaS)). Service providers can each provide a mobility service such as rideshare using the second terminal device 13 and the mobile body 14.

As an outline of the present embodiment, the information processing device 10 creates and updates a traffic plan of each mobile body 14. The traffic plan includes a travel route to be taken by the mobile body 14 via passenger boarding and alighting points of the mobile body 14. Alternatively, the traffic plan includes a travel route taken by the mobile body 14 searching for passengers. The first terminal device 12 transmits a rideshare request to the information processing device 10, which may include ancillary conditions selected together with boarding and alighting conditions. In the specification of the present application, “transmit” means to transmit a rideshare request and the like as information. The rideshare request is an application by a user of the first terminal device 12 to move from a desired boarding point to a desired alighting point using rideshare of the mobile body 14 with another person. The information processing device 10 associates the rideshare request with one of the traffic plans based on the received rideshare request. In the specification of the present application, “associate” means to associate a rideshare request, traffic plans, and the like as information. The information processing device 10 calculates a fee for the rideshare request by associating the rideshare request with the traffic plan. The information processing device 10 transmits the calculated fee to the first terminal device 12. The first terminal device 12 transmits to the information processing device 10 a confirmation of the rideshare request regarding the fee. The information processing device 10 transmits the traffic plan that has been modified based on the confirmation of the rideshare request to the second terminal device 13. The mobile body 14 equipped with the second terminal device 13 travels so as to pass through the boarding and alighting points included in the rideshare request based on the traffic plan received by the second terminal device 13.

Next, each configuration of the information processing system 11 will be described in detail.

The first terminal device 12 includes a communication unit 16, an output unit 17, an input unit 18, a storage unit 19, and a control unit 20.

The communication unit 16 includes a communication module connected to the network 15. For example, the communication unit 16 may include a communication module corresponding to a mobile communication standard such as the fourth generation (4G) and the fifth generation (5G). In the present embodiment, the first terminal device 12 is connected to the network 15 via the communication unit 16.

The communication unit 16 transmits and receives various types of information via the network 15. When transmitting information via the network 15, the communication unit 16 may add identification information of the first terminal device 12 to the information. The identification information of the first terminal device 12 is information that can uniquely identify each of the first terminal devices 12 in the information processing system 11.

The output unit 17 includes one or more interfaces that output information to notify the user. For example, the output unit 17 is, but is not limited to, a display that outputs information as images, a speaker that outputs information as audio, and the like.

The input unit 18 includes one or more interfaces for detecting a user input. The input unit 18 includes, for example, a physical key, a capacitance key, and a touch screen provided integrally with the display of the output unit 17.

The storage unit 19 is a semiconductor memory, a magnetic memory, an optical memory, or the like. However, the storage unit 19 is not limited to these. The storage unit 19 may function as, for example, a main storage device, an auxiliary storage device, or a cache memory. The storage unit 19 stores any information used for the operation of the first terminal device 12. The storage unit 19 may store, for example, a system program, an application program, or the like. The information stored in the storage unit 19 may be updatable with information received from the network 15 via the communication unit 16, for example.

The control unit 20 includes one or more processors. According to the embodiment, the “processor” is a general-purpose processor or a dedicated processor specialized for specific processing. However, the processor is not limited thereto. Dedicated processors may include application specific integrated circuits (ASICs). The control unit 20 may include a programmable logic device (PLD). The PLD may include a field-programmable gate array (FPGA). The control unit 20 controls the operation of the first terminal device 12 as a whole.

When the input unit 18 detects a user input requesting creation of a rideshare request, the control unit 20 controls the output unit 17 such that the output unit 17 outputs a request for a user input of essential items and optional items. The essential items are items necessary for each rideshare request and include boarding and alighting conditions and user attributes. The boarding and alighting conditions include a boarding point, an alighting point, and a boarding time range. The user attributes include attributes such as the user's gender and generation. As the user attributes, the user input in creating the first rideshare request to the first terminal device 12 may be used as it is in creating the subsequent rideshare requests. The optional items are items that are optionally input for each rideshare request, and include user ancillary conditions.

The user ancillary conditions are, for example, priority transportation, paved road priority, general road priority, fastest priority, a number limit, a gender limit, and a generation limit. Either at least one of the paved road priority and the general road priority or the fastest priority can be selected.

The priority transportation is, for example, to prioritize the travel of the user who creates the rideshare request (requester) between the boarding point and the alighting point over the travels of other passengers of the rideshare. The priority transportation includes full priority and partial priority. The full priority is to prioritize the alighting of the user who creates the rideshare request without letting other passengers board or alight between the boarding point and the alighting point of the user. The partial priority is to prioritize the alighting of the user who creates the rideshare request while allowing the boarding of other passengers whose boarding points are located near the route including the user's boarding and alighting points and allowing the alighting of other passengers whose alighting points are located near the route.

The paved road priority is, for example, to prioritize the passage of paved roads. The general road priority is to limit the roads to pass to roads other than toll roads. The fastest priority is to prioritize arrival in the shortest time, and includes passage of any of paved roads, rough roads, general roads, and toll roads. The number limit is to limit the number of other passengers. When the ancillary condition of the number limit is included in the rideshare request, a user input of the maximum number of other passengers is required. The gender limit is to limit the gender of other passengers to, for example, the same gender or the opposite gender. When the ancillary condition of the gender limit is included in the rideshare request, a user input of whether the gender is limited to the same gender or the opposite gender is required. The generation limit is to limit the generation of other passengers to, for example, the same generation or at least one of teens to 90s. When the ancillary condition of the generation limit is included in the rideshare request, a user input of the generation that the user desires is required.

When the input unit 18 detects a user input requesting transmission of the rideshare request, the control unit 20 controls the communication unit 16 such that the communication unit 16 transmits the rideshare request including at least the essential items to the information processing device 10. When there is a user input of the optional items, the control unit 20 includes the optional items in the rideshare request and transmits the optional items to the information processing device 10.

The control unit 20 causes the output unit 17 to output rideshare conditions received from the information processing device 10 in response to the transmission of the rideshare request. The rideshare conditions include, for example, acceptance or rejection of the rideshare request, expected arrival time at the boarding point, and estimated fees. The control unit 20 may display the expiration date and time of the rideshare conditions together with the rideshare conditions. When the input unit 18 detects the user input of the acceptance of the conditions by the expiration date and time for the rideshare conditions, the control unit 20 controls the communication unit 16 such that the communication unit 16 transmits the acceptance of the conditions to the information processing device 10.

When the control unit 20 receives the completion of acceptance from the information processing device 10 in response to the acceptance of the conditions, the control unit 20 causes the output unit 17 such that the output unit 17 outputs that the rideshare request has been accepted. In the specification of the present application, “receive” means to receive the rideshare request and the like, for example, as information.

When the input unit 18 detects the user input of adding an ancillary condition to the rideshare request after the rideshare is accepted, the control unit 20 controls the communication unit 16 such that the communication unit 16 transmits the additional ancillary condition to the information processing device 10 in combination with identification information of the rideshare request. When the control unit 20 receives an acceptance of the ancillary condition from the information processing device 10 for the additional ancillary condition, the control unit 20 causes the output unit 17 to output that the additional ancillary condition has been accepted. When the control unit 20 receives an inquiry about whether waiting is possible from the information processing device 10 with respect to the additional ancillary condition, the control unit 20 causes the output unit 17 to output the inquiry about whether waiting for acceptance of the ancillary condition is possible. When the input unit 18 detects the user input about the possibility of waiting, the control unit 20 controls the communication unit 16 such that the communication unit 16 transmits the possibility of waiting to the information processing device 10.

The information processing device 10 includes a communication unit 21, a storage unit 22, and a control unit 23.

The communication unit 21 includes a communication module connected to the network 15. For example, the communication unit 21 includes a communication module corresponding to a mobile communication standard such as the fourth generation (4G) and the fifth generation (5G). In the present embodiment, the information processing device 10 is connected to the network 15 via the communication unit 21, and communicates information with, for example, the first terminal device 12 and the second terminal device 13. When transmitting information via the network 15, the communication unit 21 may add identification information of the information processing device 10 to the information. The identification information of the information processing device 10 is information that can uniquely identify each of the information processing devices 10 in the information processing system 11.

The specific configuration and function of the storage unit 22 are the same as those of the storage unit 19 of the first terminal device 12. The storage unit 22 stores any information used for the operation of the information processing device 10, for example. The storage unit 22 stores the traffic plan of each mobile body 14.

The specific configuration of the control unit 23 is the same as that of the control unit 20 of the first terminal device 12. The control unit 23 controls the operation of the information processing device 10 as a whole.

The control unit 23 acquires time information. The time information is, for example, information indicating the current time. The control unit 23 may acquire the time information from an external server or the like through the network 15, or may acquire the time information from a timer included in the information processing device 10.

When the control unit 23 acquires the position of the mobile body 14 on which the second terminal device 13 is mounted from the second terminal device 13, the control unit 23 reads the traffic plan of the mobile body 14 from the storage unit 22. In the specification of the present application, “acquire” means to acquire a position and the like as information. The control unit 23 updates the estimated arrival times of a plurality of points on the travel route in the traffic plan, based on the difference between the predicted passage time in the traffic plan and the acquired time information of the acquired position. The control unit 23 stores the updated traffic plan in the storage unit 22.

When the control unit 23 receives a new rideshare request from the first terminal device 12, the control unit 23 stores the new rideshare request in the storage unit 22. The control unit 23 associates the new rideshare request with any of the traffic plans stored in the storage unit 22, as described below. When the control unit 23 cannot associate the new rideshare request with any of the traffic plans, the control unit 23 may control the communication unit 21 such that the communication unit 21 transmits that the rideshare is not possible to the first terminal device 12 that transmitted the new rideshare request.

As will be described in detail below, when the new rideshare request includes ancillary conditions and the existing rideshare request already associated with the traffic plan includes ancillary conditions, the control unit 23 extracts a traffic plan in which the ancillary conditions and the user attributes of the new rideshare request satisfy the ancillary conditions of the existing rideshare request and also, the ancillary conditions and the user attributes of the existing rideshare request satisfy the ancillary conditions of the new rideshare request. The control unit 23 determines extraction conditions shown below for extracting the traffic plan, for example, based on the new rideshare request and the existing rideshare request.

The control unit 23 adds, to the extraction conditions, a traffic plan in which there is no other passenger on the route including the boarding and alighting points of the new rideshare request.

The control unit 23 adds the following conditions to the extraction conditions in accordance with the ancillary conditions of the new rideshare request, for the traffic plan in which there are other passengers on the route including the boarding and alighting points of the new rideshare request. When the new rideshare request includes the ancillary condition of priority transportation, the control unit 23 adds, to the extraction conditions, a condition that there is a section in which ride is shared with the existing rideshare request (hereinafter, referred to as “rideshare section”) due to the association with the traffic plan and the existing rideshare request does not include the ancillary condition of the transportation priority. When the new rideshare request includes the ancillary condition of the priority transportation, the control unit 23 adds, to the extraction conditions, a condition that delays of boarding and alighting times of the existing rideshare request, which occur because the travel of the section between the boarding and alighting points of the new rideshare request is prioritized, are each equal to or less than a first time threshold value. When the new rideshare request includes the ancillary condition of at least one of the paved road priority and the general road priority, the control unit 23 adds, to the extraction conditions, a condition that there is a rideshare section and the existing rideshare request does not include the ancillary condition of the fastest priority. The section in which the ride is shared with the existing rideshare request is a section in which at least a part of the route including the boarding and alighting points included in the existing rideshare request overlaps with at least a part of the route including the boarding and alighting points included in the new rideshare request. When the new rideshare request includes the ancillary condition of the fastest priority, the control unit 23 adds, to the extraction conditions, a condition that there is a rideshare section and the existing rideshare request does not include either of the ancillary conditions of the paved road priority and the general road priority. When the new rideshare request includes the ancillary condition of the number limit, the control unit 23 adds, to the extraction conditions, a condition that the number of other passengers in the rideshare section is equal to or less than the upper limit of the number limit. When the new rideshare request includes the ancillary condition of the gender limit, the control unit 23 adds, to the extraction conditions, a condition that the gender of all the other passengers in the rideshare section matches the gender set by the gender limit. When the new rideshare request includes the ancillary condition of the generation limit, the control unit 23 adds, to the extraction conditions, a condition that the generations of all the other passengers in the rideshare section match the generations set by the generation limit.

The control unit 23 further adds the following conditions to the extraction conditions in accordance with the ancillary conditions of the existing rideshare request, for the traffic plan in which there are other passengers on the route including the boarding and alighting points of the new rideshare request. When the existing rideshare request includes the ancillary condition of the full priority, the control unit 23 adds, to the extraction conditions, a condition that the route including the boarding and alighting points of the new rideshare request is outside the route including the boarding and alighting points of the existing rideshare request. When the existing rideshare request includes the ancillary condition of the partial priority, the control unit 23 adds, to the extraction conditions, a condition that at least one of the boarding and alighting points of the new rideshare request is in the vicinity of the route including the boarding and alighting points of the existing rideshare request. The vicinity of the route including the boarding and alighting points means, for example, that an additional travel distance from the departure from the route to the return to the route is equal to or less than a distance threshold value, or an additional travel time from the departure from the route to the return to the route is equal to or less than a second time threshold value. When the existing rideshare request includes the ancillary condition of the number limit, the control unit 23 adds, to the extraction conditions, a condition that the number of people added due to the new rideshare request is equal to or less than the upper limit of the number limit, in the rideshare section of the new rideshare request with respect to the existing rideshare request. When the existing rideshare request includes the ancillary condition of the gender limit, the control unit 23 adds, to the extraction conditions, a condition that there is a rideshare section of the new rideshare request with respect to the existing rideshare request and the gender included in the new rideshare request matches the gender set by the gender limit. When the existing rideshare request includes the ancillary condition of the generation limit, the control unit 23 adds, to the extraction conditions, a condition that there is a rideshare section of the new rideshare request with respect to the existing rideshare request and the generations included in the new rideshare request match the generations set by the generation limit.

The control unit 23 adds, to the extraction conditions, a traffic plan that allows arrival at the boarding point of the new rideshare request within a boardable time of the new rideshare request.

The control unit 23 extracts a traffic plan that satisfies the above-mentioned extraction conditions from the traffic plans stored in the storage unit 22. The control unit 23 calculates an additional route to travel between the travel route of the extracted traffic plan and the boarding and alighting points of the new rideshare request, or an additional time required to travel the additional route. The control unit 23 selects a traffic plan with a minimum calculated additional route or additional time.

The control unit 23 creates a tentative travel route for a case where the new rideshare request is tentatively associated with the selected traffic plan. The control unit 23 calculates an expected arrival time at the boarding point of the new rideshare request on the created tentative travel route. The control unit 23 calculates a fee for the new rideshare request tentatively associated with the selected traffic plan.

For example, the control unit 23 increases the fee as the distance of the route between the boarding and alighting points of the new rideshare request becomes longer. For example, the control unit 23 reduces the fee depending on the number of other passengers in the rideshare section of the new rideshare request.

The control unit 23 calculates the fee based on at least one of the types and number of ancillary conditions of the new rideshare request. More specifically, the control unit 23 increases the fee in accordance with, for example, the number of ancillary conditions. For example, the control unit 23 sets the amount of increase in fee to be larger for the ancillary condition of the priority transportation than for the other ancillary conditions. For example, the control unit 23 sets the amount of increase in fee to be larger for the ancillary condition of the full priority than for the ancillary condition of the partial priority. The control unit 23 reduces the fee, for example, when the new rideshare request includes no ancillary condition and the existing rideshare request having the rideshare section with the new rideshare request includes ancillary conditions.

Further, when the new rideshare request includes ancillary conditions, the control unit 23 may increase the fee in accordance with the number of ancillary conditions included in the rideshare requests effective during the boarding period of the new rideshare request, out of all the rideshare requests stored in the storage unit 22. The rideshare requests effective during the boarding period of the new rideshare request are rideshare requests each including a boarding period that overlaps at least a part of the boarding period of the new rideshare request.

The control unit 23 controls the communication unit 21 such that the communication unit 21 transmits the rideshare conditions including the estimated arrival time at the boarding point of the new rideshare request and a fee for the new rideshare request to the first terminal device 12 that transmitted the new rideshare request. The control unit 23 may transmit the expiration date and time of the rideshare conditions together with the rideshare conditions. The expiration date and time may be an absolute deadline and may vary depending on the time from the current time to the expected arrival time at the boarding point.

When the control unit 23 receives the acceptance of the conditions for the rideshare conditions from the first terminal device 12, the control unit 23 confirms the tentative association of the traffic plan with the new rideshare request by the expiration date and time. The control unit 23 stores the association between the new rideshare request and the confirmed traffic plan in the storage unit 22. The control unit 23 modifies the travel route in the subsequent traffic plan with the created tentative travel route. The control unit 23 stores the modified travel route in the storage unit 22. The control unit 23 may reject the new rideshare request when the control unit 23 cannot receive the acceptance of the conditions by the expiration date and time.

The control unit 23 controls the communication unit 21 such that the communication unit 21 transmits the traffic plan including the modified travel route to the second terminal device 13. The control unit 23 controls the communication unit 21 such that the communication unit 21 transmits the completion of acceptance of the new rideshare request to the first terminal device 12 that transmitted the acceptance of the conditions. The control unit 23 recalculates the fee for the existing rideshare request with respect to the association with the new rideshare request, and controls the communication unit 21 such that the communication unit 21 transmits the recalculated fee to the first terminal device 12 that transmitted the existing rideshare request. Here, the acceptance of the new rideshare request can increase the rideshare section with respect to the existing rideshare request. Therefore, the fee that has already been notified to each existing rideshare request can be reduced.

When the control unit 23 receives from the second terminal device 13 that the user of the first terminal device 12 that transmitted the rideshare request has alighted from the mobile body 14, the control unit 23 clears the association of the rideshare request with the traffic plan.

When the control unit 23 receives the additional ancillary condition from the first terminal device 12, the control unit 23 reads out from the storage unit 22 other rideshare requests associated with the same traffic plan as the rideshare request transmitted from the first terminal device 12.

The control unit 23 determines whether the read other existing rideshare requests satisfy the additional ancillary condition. More specifically, the control unit 23 determines whether the additional ancillary condition satisfies the ancillary condition of the existing rideshare request and whether the ancillary condition and the user attributes of the existing rideshare request satisfy the additional ancillary condition. When the other existing rideshare requests satisfy the additional ancillary condition over the entire route from the boarding point corresponding to the additional ancillary condition or the position of the mobile body 14 to the alighting point corresponding to the additional ancillary condition, the control unit 23 controls the communication unit 21 such that the communication unit 21 transmits to the first terminal device 12 the ancillary condition acceptance indicating acceptance of the additional ancillary condition. For example, on the route from the alighting point of the existing rideshare request that does not satisfy the additional ancillary condition, among the other existing rideshare requests, to the alighting point corresponding to the additional ancillary condition, the control unit 23 controls the communication unit 21 such that the communication unit 21 transmits an inquiry about whether waiting for the addition of the ancillary condition is possible to the first terminal device 12. When the control unit 23 receives from the first terminal device 12 a response about the possibility of waiting with respect to the inquiry about whether waiting is possible, the control unit 23 controls the communication unit 21 such that the communication unit 21 transmits the ancillary condition acceptance indicating the acceptance of the additional ancillary condition to the first terminal device 12.

The control unit 23 may modify the fee based on the additional ancillary condition and transmit the modified fee to the first terminal device 12 together with the ancillary condition acceptance. When the additional ancillary condition is not satisfied by all the other existing rideshare requests over the entire route from the boarding point to the alighting point corresponding to the additional ancillary condition, the control unit 23 rejects the additional ancillary condition and controls the communication unit 21 such that the communication unit 21 transmits a rejection notice to the first terminal device 12.

When the control unit 23 accepts the additional ancillary condition, the control unit 23 modifies the boarding point corresponding to the additional ancillary condition, the position of the mobile body 14, or the travel route after the alighting point of the other rideshare request, based on the additional ancillary condition. The control unit 23 controls the communication unit 21 such that the communication unit 21 transmits the traffic plan including the modified travel route to the second terminal device 13.

As described above, the second terminal device 13 is mounted on the mobile body 14 and is used in the mobile body 14, for example. The mobile body 14 is, for example, an autonomous driving vehicle capable of autonomous driving or follow-up traveling, but is not limited to this, and may be any vehicle on which the second terminal device 13 can be mounted.

The second terminal device 13 automatically generates control information with the autonomous driving control software and transmits the control information to the mobile body 14. The mobile body 14 performs a vehicle control based on the received control information. The vehicle control is, for example, autonomous driving, but is not limited to this. At least part of the application programming interface (API) that defines the specifications of the control information is disclosed to the service provider. The service provider can freely program the autonomous driving control software of the second terminal device 13 using the disclosed API. Therefore, the service provider can provide any mobility service by installing the equipment suitable for the purpose in the vehicle cabin of the mobile body 14 and programming the autonomous driving control software using the API suitable for the purpose.

The second terminal device 13 includes a communication unit 24, a storage unit 25, and a control unit 26.

The communication unit 24 includes a communication module that communicates via an in-vehicle network such as a controller area network (CAN) of the mobile body 14 or a dedicated line. The communication unit 24 includes a communication module connected to the network 15. For example, the communication unit 24 may include a communication module corresponding to a mobile communication standard such as the fourth generation (4G) and the fifth generation (5G).

In the present embodiment, the second terminal device 13 communicates information with an on-board device such as a position information acquisition device 27 of the mobile body 14 via the communication unit 24.

The position information acquisition device 27 includes one or more receivers corresponding to any satellite positioning system. For example, the position information acquisition device 27 may include a global positioning system (GPS) receiver. The position information acquisition device 27 acquires a measured value of the position of the mobile body 14 as information and transmits it to the second terminal device 13. The position information acquisition device 27 periodically acquires and transmits the measured value. The position information acquisition device 27 may be built in the second terminal device 13.

Further, the second terminal device 13 is connected to the network 15 via the communication unit 24 or the communication unit 24 and the communication device 28 of the mobile body 14, and transmits and receives various information via the network 15. The communication device 28 is, for example, a dedicated in-vehicle communication device. The communication device 28 may include a communication module corresponding to a mobile communication standard such as the fourth generation (4G) and the fifth generation (5G) in order to connect to the network 15. When transmitting information via the network 15, the communication unit 24 may add identification information of the second terminal device 13 to the information. The identification information of the second terminal device 13 is information that can uniquely identify each of the second terminal devices 13 in the information processing system 11.

The specific configuration and function of the storage unit 25 are the same as those of the storage unit 19 of the first terminal device 12. The storage unit 25 stores any information used for the operation of the second terminal device 13, for example.

The specific configuration of the control unit 26 is the same as that of the control unit 20 of the first terminal device 12. The control unit 26 controls the operation of the second terminal device 13 as a whole.

The control unit 26 controls the communication unit 24 such that the communication unit 24 regularly or periodically transmits the position of the mobile body 14 acquired from the position information acquisition device 27 to the information processing device 10. When the control unit 26 receives the traffic plan from the information processing device 10, the control unit 26 stores the traffic plan in the storage unit 25.

The control unit 26 causes the mobile body 14 to travel along the travel route of the latest traffic plan stored in the storage unit 25. For example, the control unit 26 generates control information for autonomous driving corresponding to the traffic plan and transmits it to the mobile body 14 so that the mobile body 14 travels along the travel route. Alternatively, when the mobile body 14 is not an autonomous driving vehicle, the control unit 26 may cause a display or the like to output the travel route of the traffic plan and cause the driver to drive along the travel route so that the mobile body 14 travels.

The control unit 26 may transmit to the information processing device 10 a confirmation that the user of the first terminal device 12 that transmitted the rideshare request has boarded the mobile body 14 at the boarding point on the travel route of the latest traffic plan stored in the storage unit 25. The confirmation of boarding may be performed, for example, by short-range wireless communication of the second terminal device 13 and the first terminal device 12, or by a user input to an input unit provided in the second terminal device 13.

The control unit 26 may transmit to the information processing device 10 a confirmation that the user of the first terminal device 12 that transmitted the rideshare request has alighted from the mobile body 14 at the alighting point on the travel route of the latest traffic plan stored in the storage unit 25. The confirmation of alighting may be performed, for example, by short-range wireless communication of the second terminal device 13 and the first terminal device 12, or by a user input to the input unit provided in the second terminal device 13.

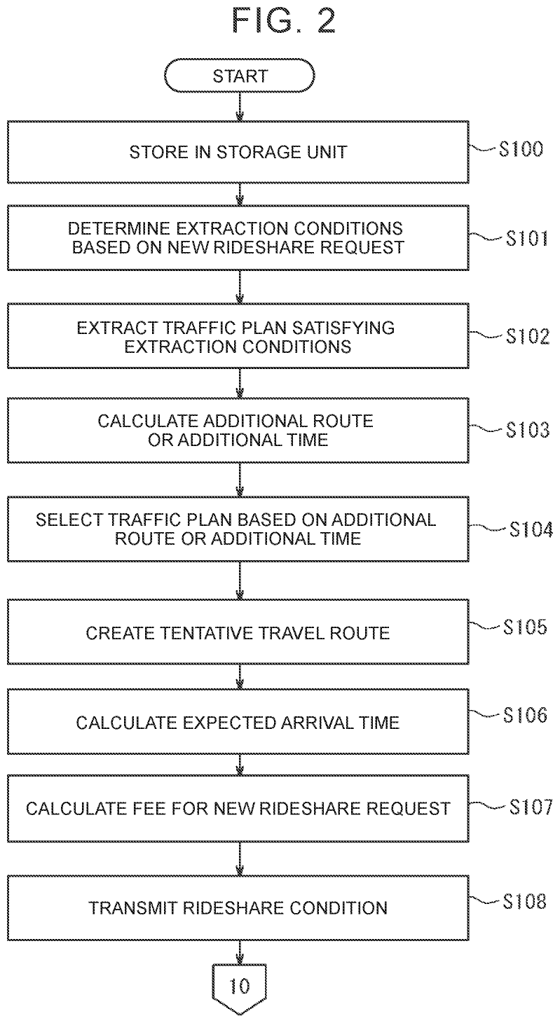

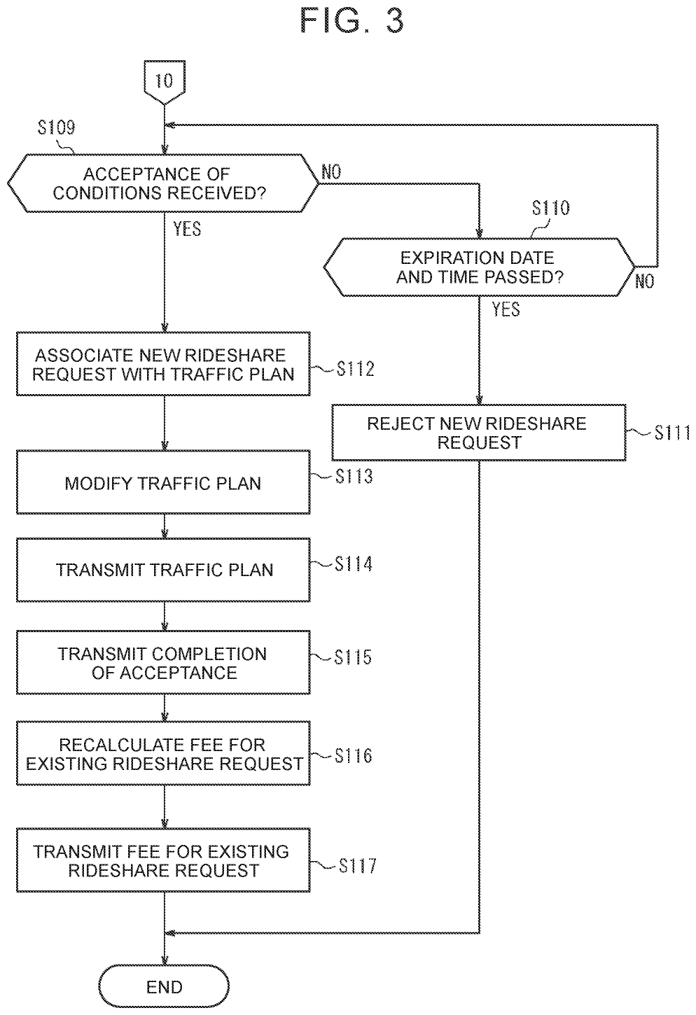

Next, the association process executed by the control unit 23 of the information processing device 10 in the present embodiment will be described with reference to flowcharts of FIGS. 2 and 3. The association process starts when a new rideshare request is received from a first terminal device 12.

In step S100, the control unit 23 stores the new rideshare request in the storage unit 22. After storage, the process proceeds to step S101.

In step S101, the control unit 23 determines the extraction conditions of the traffic plan based on the new rideshare request stored in step S100. After determination, the process proceeds to step S102.

In step S102, the control unit 23 extracts from the storage unit 22 a traffic plan that satisfies the extraction conditions determined in step S101. After extraction, the process proceeds to step S103.

In step S103, the control unit 23 calculates an additional route to travel between the travel route of the traffic plan extracted in step S102 and the boarding and alighting points of the new rideshare request stored in step S100, or an additional time required to travel the additional route. After calculation, the process proceeds to step S104.

In step S104, the control unit 23 selects the traffic plan with the additional route or the additional time calculated in step S103 being minimum. After selection, the process proceeds to step S105.

In step S105, the control unit 23 creates a tentative travel route by including the boarding and alighting points of the new rideshare request stored in step S100 in the traffic plan selected in step S104. After creation, the process proceeds to step S106.

In step S106, the control unit 23 calculates an expected arrival time at the boarding point of the new rideshare request stored in step S100 on the tentative travel route created in step S105. After calculation, the process proceeds to step S107.

In step S107, the control unit 23 calculates a fee for the new rideshare request for a case where the new rideshare request stored in step S100 is tentatively associated with the traffic plan selected in step S104. After calculation, the process proceeds to step S108.

In step S108, the control unit 23 controls the communication unit 21 such that the communication unit 21 transmits to the first terminal device 12 rideshare conditions including the estimated arrival time calculated in step S106 and the fee calculated in step S107. After transmission, the process proceeds to step S109.

In step S109, the control unit 23 determines whether the acceptance of the conditions has been received from the first terminal device 12 with respect to the rideshare conditions transmitted in step S108. When the acceptance is not received, the process proceeds to step S110. When the acceptance is received, the process proceeds to step S112.

In step S110, the control unit 23 determines whether the expiration date and time have passed after the transmission of the rideshare conditions in step S108. When the expiration date and time have not passed, the process returns to step S109. When the expiration date and time have passed, the process proceeds to step S111.

In step S111, the control unit 23 rejects the new rideshare request stored in step S100. After rejection, the association process ends.

In step S112, the control unit 23 stores the association of the new rideshare request stored in step S100 with the traffic plan selected in step S104 in the storage unit 22 so as to associate the new rideshare request with the traffic plan. After the association, the process proceeds to step S113.

In step S113, the control unit 23 changes the travel route in the traffic plan associated with the new rideshare request in step S112 to the tentative travel route created in step S105 to modify the traffic plan. The control unit 23 stores the modified traffic plan in the storage unit 22. After modification, the process proceeds to step S114.

In step S114, the control unit 23 controls the communication unit 21 such that the communication unit 21 transmits the traffic plan modified in step S113 to the second terminal device 13 corresponding to the traffic plan. After transmission, the process proceeds to step S115.

In step S115, the control unit 23 controls the communication unit 21 such that the communication unit 21 transmits the completion of acceptance of the new rideshare request to the first terminal device 12 that transmitted the acceptance of the conditions in step S109. After transmission, the process proceeds to step S116.

In step S116, the control unit 23 recalculates the fee for the existing rideshare request of the traffic plan by associating the traffic plan selected in step S104 with the new rideshare request. After recalculation, the process proceeds to step S117.

In step S117, the control unit 23 controls the communication unit 21 such that the communication unit 21 transmits the fee calculated in step S116 to the second terminal device 13 that transmitted each existing rideshare request. After transmission, the association process ends.

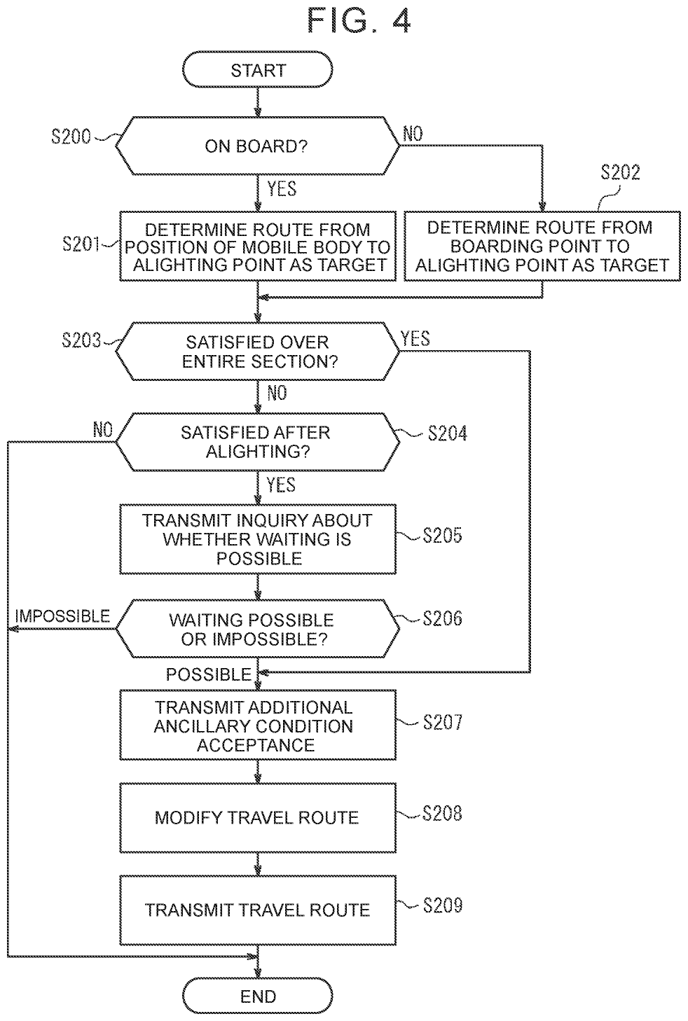

Next, the ancillary condition addition process executed by the control unit 23 of the information processing device 10 in the present embodiment will be described with reference to a flowchart of FIG. 4. The ancillary condition addition process starts when the additional ancillary condition is received from the first terminal device 12 that transmitted the rideshare request associated with the traffic plan.

In step S200, the control unit 23 determines whether the user of the first terminal device 12 who transmitted the additional ancillary condition is on the mobile body 14. For example, the control unit 23 reads from the storage unit 22 the traffic plan associated with the rideshare request corresponding to the additional ancillary condition. When the control unit 23 has received a confirmation from the second terminal device 13 that the user of the first terminal device 12 who transmitted the rideshare request has boarded, with respect to the traffic plan, the control unit 23 determines that the user is on board. When the control unit 23 has not received a confirmation from the second terminal device 13 that the user has boarded, the control unit 23 determines that the user has not boarded. When the user is on board, the process proceeds to step S201. When the user has not boarded, the process proceeds to step S202.

In step S201, the control unit 23 determines the route from the position of the mobile body 14 to the alighting point of the rideshare request corresponding to the additional ancillary condition as a determination target of acceptance or rejection of the additional ancillary condition. After determination, the process proceeds to step S203.

In step S202, the control unit 23 determines the route from the boarding point to the alighting point of the rideshare request corresponding to the additional ancillary condition as the determination target of acceptance or rejection of the additional ancillary condition. After determination, the process proceeds to step S203.

In step S203, the control unit 23 determines whether the other existing rideshare requests associated with the traffic plan read in step S200 satisfy the additional ancillary condition over the entire section that is determined to be the determination target in step S201 or step S202. When the additional ancillary condition is satisfied over the entire section, the process proceeds to step S207. When the additional ancillary condition is not satisfied over the entire section, the process proceeds to step S204.

In step S204, the control unit 23 determines whether, on the route after passing the alighting point of the other existing rideshare request, yet another existing rideshare request satisfies the additional ancillary condition. When the additional ancillary condition is satisfied, the process proceeds to step S205. When the additional ancillary condition is not satisfied, the ancillary condition addition process ends.

In step S205, the control unit 23 controls the communication unit 21 such that the communication unit 21 transmits the inquiry about whether waiting is possible to the first terminal device 12 that transmitted the additional ancillary condition. After transmission, the process proceeds to step S206.

In step S206, the control unit 23 determines whether being possible or impossible to wait has been received from the first terminal device 12. When being possible to wait is received, the process proceeds to step S207. When being impossible to wait is received, the ancillary condition addition process ends.

In step S207, the control unit 23 controls the communication unit 21 such that the communication unit 21 transmits the additional ancillary condition acceptance to the first terminal device 12. After transmission, the process proceeds to step S208.

In step S208, the control unit 23 modifies the boarding point corresponding to the additional ancillary condition, the position of the mobile body 14, or the travel route after the alighting point of the other rideshare request, based on the additional ancillary condition. After modification, the process proceeds to step S209.

In step S209, the control unit 23 controls the communication unit 21 such that the communication unit 21 transmits the travel route modified in step S208 to the second terminal device 13. After transmission, the ancillary condition addition process ends.

When the new rideshare request includes ancillary conditions and the existing rideshare request associated with the traffic plan includes ancillary conditions, the information processing device 10 of the present embodiment having the above configuration associates the new rideshare request with the traffic plan in which the ancillary conditions and the user attributes of the new rideshare request satisfy the ancillary conditions of the existing rideshare request and the ancillary conditions and the user attributes of the existing rideshare request satisfy the ancillary conditions of the new rideshare request. With such a configuration, the information processing device 10 can provide an opportunity of rideshare while satisfying ancillary conditions that are difficult to be satisfied in normal rideshare. There may be a case where, when the ancillary conditions of someone requesting rideshare are simply satisfied, another person requesting rideshare does not want to ride together, which makes the rideshare difficult to be established. Therefore, the information processing device 10 calculates the fee for the new rideshare request based on at least one of the types and number of ancillary conditions of the new rideshare request. With such a configuration, the information processing device 10 can adjust, with the fee, the inequity between passengers due to the difference in ancillary conditions satisfied. Thus, the information processing device 10 can improve establishment of rideshare while satisfying the ancillary conditions. Therefore, the information processing device 10 can satisfy the ancillary conditions of the rideshare requesters.

When the new rideshare request does not include the ancillary conditions and the existing rideshare request includes the ancillary conditions, the information processing device 10 of the present embodiment reduces the fee for the new rideshare request. With such a configuration, the information processing device 10 can provide rideshare to users having no ancillary condition at fees lower than the normal rideshare fee.

When the information processing device 10 of the present embodiment receives the new rideshare request including ancillary conditions, the information processing device 10 increases the fee for the new rideshare request in accordance with the number of ancillary conditions included in the received rideshare request that are effective during a scheduled boarding period of the new rideshare request. As the number of ancillary conditions increases in the entire information processing system 11, it becomes more difficult to associate the new rideshare request with the traffic plan. In response to such an event, the information processing device 10 having the above-described configuration determines the fee in accordance with demand of the ancillary conditions, so that the demand of the ancillary conditions can be adjusted.

When the information processing device 10 of the present embodiment receives an additional ancillary condition from the first terminal device 12 that transmitted the rideshare request associated with the traffic plan and all the existing rideshare requests associated with the traffic plan satisfy the ancillary condition, the information processing device 10 accepts the ancillary condition. With such a configuration, the information processing device 10 can accept ancillary conditions not only at the time of new rideshare request but also after accepting the new rideshare request.

The information processing device 10 of the present embodiment accepts the additional ancillary condition after passing the alighting point of the existing rideshare request, of the rideshare requests associated with the traffic plan, that does not satisfy the additional ancillary condition. With such a configuration, the information processing device 10 can satisfy the ancillary conditions of the user even in a part of the section between the boarding and alighting points.

Although the embodiment has been described above based on the drawings and examples, it should be noted that those skilled in the art can easily make various modifications and alterations thereto based on the present disclosure. It should be noted, therefore, that these modifications and alterations are within the scope of the present disclosure. For example, the functions included in each configuration or each step can be rearranged so as not to be logically inconsistent, and a plurality of units or steps can be combined into one, or one unit or step can be divided.

For example, in the above-described embodiment, some processing operations performed in the information processing device 10, the first terminal device 12, and the second terminal device 13 may be performed in another device.

Further, for example, a configuration is possible in which a general-purpose electronic device such as a smartphone or a computer functions as the information processing device 10, the first terminal device 12, and the second terminal device 13 according to the above-described embodiment. Specifically, a program including processing content for realizing each function, such as the information processing device 10, the first terminal device 12, and the second terminal device 13 according to the embodiment, is stored in a memory of the electronic device, and the program is read and executed by the processor of the electronic device. Thus, the disclosure according to the embodiment can also be realized as a program that can be executed by the processor. The program may be downloaded via the network 15 or stored in a portable, non-transitory recording/storage medium readable by an electronic device and may be read by the electronic device from the medium.

What is claimed is:

1. An information processing device, comprising:
a communication unit that communicates information with a first terminal device; and
a control unit that associates a new rideshare request with a traffic plan of a mobile body based on a user attribute, when the communication unit receives the new rideshare request including boarding and alighting conditions and the user attribute from the first terminal device, wherein when the new rideshare request further includes an ancillary condition and an existing rideshare request associated with the traffic plan includes the ancillary condition, the control unit associates the new rideshare request with the traffic plan in which the ancillary condition and the user attribute of the new rideshare request satisfy the ancillary condition of the existing rideshare request and the ancillary condition and a user attribute of the existing rideshare request satisfy the ancillary condition of new the rideshare request, and calculates a fee for the new rideshare request based on at least one of a type and the number of the ancillary conditions for the new rideshare request.

2. The information processing device according to claim 1, wherein the control unit reduces the fee for the new rideshare request when the new rideshare request includes no ancillary condition and the existing rideshare request includes the ancillary condition.

3. The information processing device according to claim 1, wherein the ancillary condition includes at least one of priority transportation, paved road priority, general road priority, fastest priority, a number limit, a gender limit, and a generation limit.

4. The information processing device according to claim 3, wherein the priority transportation includes full priority and partial priority, the full priority giving priority to alighting of a requester, and the partial priority allowing at least one of alighting of another passenger with an alighting point in a vicinity of a route to an alighting point of the requester and boarding of the requester with a boarding point in the vicinity of the route.

5. The information processing device according to claim 3, wherein the control unit associates the new rideshare request that includes the priority transportation as the ancillary condition with the traffic plan associated with the existing rideshare request that does not include the priority transportation as the ancillary condition.

6. The information processing device according to claim 1, wherein when the control unit receives the new rideshare request including the ancillary condition, the control unit increases the fee for the new rideshare request in accordance with the number of the ancillary conditions of another rideshare request that are effective during a scheduled boarding period under the boarding and alighting conditions of the new rideshare request.

7. The information processing device according to claim 1, wherein when the control unit newly receives an ancillary condition from the first terminal device that transmitted the existing rideshare request associated with the traffic plan and all the existing rideshare requests associated with the traffic plan satisfy the ancillary condition, the control unit accepts the ancillary condition.

8. The information processing device according to claim 7, wherein the control unit accepts the ancillary condition after passage through an alighting point of the existing rideshare request, of the existing rideshare requests associated with the traffic plan, that does not satisfy the newly received ancillary condition.

9. An information processing system, comprising:
the information processing device according to claim 1;
the first terminal device; and
a second terminal device that communicates the traffic plan with the information processing device.

10. A program that causes a computer to perform operations including:
receiving a new rideshare request from a first terminal device;
in execution of association of the new rideshare request with a traffic plan of a mobile body based on a user attribute in a case of receiving the new rideshare request including boarding and alighting conditions and the user attribute from the first terminal device, when the new rideshare request further includes an ancillary condition and an existing rideshare request associated with the traffic plan includes an ancillary condition, associating the new rideshare request with the traffic plan in which the ancillary condition and the user attribute of the new rideshare request satisfy the ancillary condition of the existing rideshare request and the ancillary condition and a user attribute of the existing rideshare request satisfy the ancillary condition of the new rideshare request; and
determining a fee for the new rideshare request based on at least one of a type and the number of the ancillary conditions for the new rideshare request.

11. The program according to claim 10, the program causing the computer to perform the operations that further include reducing the fee for the new rideshare request when the new rideshare request includes no ancillary condition and the existing rideshare request includes the ancillary condition.

12. The program according to claim 10, wherein the ancillary condition includes at least one of priority transportation, paved road priority, fastest priority, general road priority, a number limit, a gender limit, and a generation limit.

13. The program according to claim 12, wherein the priority transportation includes full priority that gives priority to alighting of a requester and partial priority that allows alighting of another passenger with an alighting point on a route to an alighting point of the requester and boarding of the requester with a boarding point on the route.

14. The program according to claim 12, the program causing the computer to perform the operations that further include associating the new rideshare request including the priority transportation as the ancillary condition with the traffic plan associated with the existing rideshare request that does not include the priority transportation as the ancillary condition.

15. An information processing method performed by a computer, the computer
receiving a new rideshare request from a first terminal device,
in execution of association of the new rideshare request with a traffic plan of a mobile body based on a user attribute in a case of receiving the new rideshare request including boarding and alighting conditions and the user attribute from the first terminal device, when the new rideshare request further includes an ancillary condition and an existing rideshare request associated with the traffic plan includes an ancillary condition, associating the new rideshare request with the traffic plan in which the ancillary condition and the user attribute of the new rideshare request satisfy the ancillary condition of the existing rideshare request and the ancillary condition and a user attribute of the existing rideshare request satisfy the ancillary condition of the new rideshare request, and
determining a fee for the new rideshare request based on at least one of a type and the number of the ancillary conditions for the new rideshare request.

16. The information processing method according to claim 15, wherein the computer reduces the fee for the new rideshare request when the new rideshare request includes no ancillary condition and the existing rideshare request includes the ancillary condition.

17. The information processing method according to claim 15, wherein the ancillary condition includes at least one of priority transportation, paved road priority, fastest priority, general road priority, a number limit, a gender limit, and a generation limit.

18. The information processing method according to claim 17, wherein the priority transportation includes full priority that gives priority to alighting of a requester and partial priority that allows alighting of another passenger with an alighting point on a route to an alighting point of the requester and boarding of the requester with a boarding point on the route.

19. The information processing method according to claim 17, wherein the computer associates the new rideshare request including the priority transportation as the ancillary condition with the traffic plan associated with an existing rideshare request that does not include the priority transportation as the ancillary condition.

20. The information processing method according to claim 15, wherein the computer increases the fee for the new rideshare request in accordance with the number of the ancillary conditions of another rideshare request that are effective during a scheduled boarding period under the boarding and alighting conditions of the new rideshare request, when receiving the new rideshare request including the ancillary condition.
